(19) United States
(12) Patent Application Publication
(10) Pub. No.: US 2023/0305186 A1
(43) Pub. Date: Sep. 28, 2023

(54) METHOD AND SYSTEM FOR PREDICTING STRESS-DEPENDENT FRACTURE PERMEABILITY

(71) Applicants: SAUDI ARABIAN OIL COMPANY, Dhahran (SA); King Abdullah University of Science and Technology, Thuwal-Jeddah (SA)

(72) Inventors: Marwah Mufid Alsinan, Al Qatif (SA); Xupeng He, Thuwal (SA); Hyung Tae Kwak, Dhahran (SA); Hussein Hoteit, Thuwal (SA)

(73) Assignees: SAUDI ARABIAN OIL COMPANY, Dhahran (SA); King Abdullah University of Science and Technology, Thuwal-Jeddah (SA)

(21) Appl. No.: 17/656,831

(22) Filed: Mar. 28, 2022

(51) Int. Cl. G01V 99/00; G01N 15/08; E21B 41/00; E21B 49/00

(52) U.S. Cl. CPC G01V 99/005; G01N 15/0806; E21B 41/00; E21B 49/00; E21B 2200/20

(57) ABSTRACT

A method is disclosed for modeling fluid flow through a fracture. The method includes obtaining a normal stress, and a shear stress and determining a first three-dimensional (3D) aperture model. Further, the method includes estimating a normal fracture closure displacement under the normal stress and a fracture dilation under the shear stress and simulating a fluid flow through a second 3D aperture model of the fracture. The second 3D aperture model of the fracture is based on the first 3D aperture, the normal fracture closure displacement, and the fracture dilation. Additionally, the method includes calculating a permeability of the second 3D aperture model of the fracture based on the simulated fluid flow.

### BACKGROUND

Accurate modeling of fluid flow through subsurface fractured rocks is of great interest in various environmental and energy applications such as CO2 sequestration, geothermal energy extraction, and the oil and gas recovery process in naturally and hydraulically fractured reservoirs.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to a method for modeling fluid flow through a fracture, which includes obtaining a geometry of the fracture and determining, using a computer processor, a first three-dimensional (3D) aperture model of the fracture. Further, the method includes estimating, using the computer processor, a normal fracture closure displacement of the first 3D aperture model of the fracture under a normal stress and estimating, using the computer processor, a fracture dilation of the first 3D aperture model of the fracture under a shear stress. The method further includes determining, using the computer processor, a second 3D aperture model of the fracture, wherein the second 3D aperture model is based, at least in part, on the first 3D aperture model, the normal fracture closure displacement, and the fracture dilation, simulating, using the computer processor, a fluid flow through the second 3D aperture model, and determining, using the computer processor, a permeability of the second 3D aperture model, at least in part, on the simulated fluid flow.

In one aspect, the invention relates to a non-transitory computer readable medium storing program instructions that, when executed, are configured to perform a method for modeling fluid flow through a fracture. The instructions, when executed, determine a first three-dimensional (3D) aperture model of a fracture, estimate a normal fracture closure displacement of the first 3D aperture model of the fracture under a normal stress, and estimate a fracture dilation of the first 3D aperture model of the fracture under a shear stress. The instructions, when executed, further determine a second 3D aperture model of the fracture, wherein the second 3D aperture model is based, at least in part, on the first 3D aperture model, the normal fracture closure displacement, and the fracture dilation, simulate a fluid flow through the second 3D aperture model, and determine a permeability of the second 3D aperture model, at least in part, on the simulated fluid flow.

In one aspect, embodiments disclosed herein relate to a system which includes a geometry measuring tool, and a computer processor. The computer processor is configured to obtain a geometry of a three-dimensional (3D) aperture of a fracture, a normal stress, and a shear stress, based on measurements of the geometry measuring tool and determine a first three-dimensional (3D) aperture model of the fracture. Further, the computer processor is configured to estimate a normal fracture closure displacement of the first 3D aperture model of the fracture under the normal stress and estimate a fracture dilation of the first 3D aperture model of the fracture under the shear stress. Further, the computer processor is configured to determine a second 3D aperture model of the fracture, wherein the second 3D aperture model is based, at least in part, on the first 3D aperture model, the normal fracture closure displacement, and the fracture dilation, simulate a fluid flow through the second 3D aperture model, and determine permeability of the second 3D aperture model, at least in part, on the simulated fluid flow.

Other aspects and advantages of the claimed subject matter will be apparent from the following description and the appended claims.

### BRIEF DESCRIPTION OF DRAWINGS

Specific embodiments disclosed herein will now be described in detail with reference to the accompanying figures. Like elements in the various figures are denoted by like reference numerals for consistency. Like elements may not be labeled in all figures for the sake of simplicity.

FIG. 1 shows a system in accordance with one or more embodiments.

FIG. 2 shows a flowchart in accordance with one or more embodiments.

FIGS. 3A-3B show cross sections of 3D rock fractures in accordance with one or more embodiments.

FIG. 4 shows cross sections of 3D rock fractures in accordance with one or more embodiments.

FIG. 5 shows geometric variations and mechanical and hydraulic behaviors under normal-flow-stress conditions in accordance with one or more embodiments.

FIG. 6 shows a 3D aperture updated with normal displacement and shear dilation in accordance with one or more embodiments.

FIGS. 7A-7C show geometric variations and mechanical and hydraulic behaviors of a fracture under shear-displacement conditions in accordance with one or more embodiments.

FIG. 8 shows a graph representing comparison between the proposed algorithm and experimental measurements in accordance with one or more embodiments.

FIG. 9 shows a computer system in accordance with one or more embodiments.

### DETAILED DESCRIPTION

In the following detailed description of embodiments disclosed herein, numerous specific details are set forth in order to provide a more thorough understanding disclosed herein. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

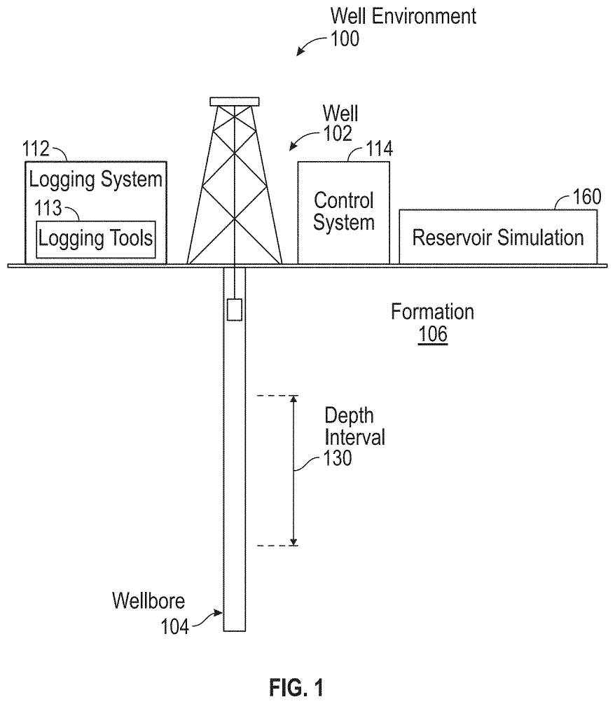

In the following description of FIGS. 1-9, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a horizontal beam” includes reference to one or more of such beams.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims without departing from the scope of this disclosure.

Embodiments disclosed herein provide a method and a system for predicting stress-dependent fracture permeability under normal and shear deformation through a coupled flow-geomechanics simulation. Geomechanics is the study of how subsurface rocks deform or fail in response to changes of stress, pressure and temperature. The in-situ rock fractures are subjected to both normal and shear stresses, leading to a variation in fracture aperture, further influencing hydraulic properties. In other words, the hydraulic response of subsurface rock fractures is stress-dependent. Embodiments of this disclosure describe methods and systems that may improve the accuracy of calculations of the flow rate and the corresponding permeability and validate the predicted permeability using fracture permeability experiments under shear and normal stress.

FIG. 1 shows a schematic diagram in accordance with one or more embodiments.

FIG. 1 illustrates a well environment (100) that may include a well (102) having a wellbore (104) extending into a formation (106). The wellbore (104) may include a bore hole that extends from the surface into a target zone of the formation (106), such as a reservoir. The formation (106) may include various formation characteristics of interest, such as formation porosity, formation permeability, resistivity, density, water saturation, and the like. Porosity indicates how much space exists in a particular rock within an area of interest in the formation (106), where oil, gas, and/or water may be trapped. Permeability indicates the ability of liquids and gases to flow through the rock within the area of interest. Resistivity indicates how strongly rock and/or fluid within the formation (106) opposes the flow of electrical current. For example, resistivity may be indicative of the porosity of the formation (106) and the presence of hydrocarbons. More specifically, resistivity may be relatively low for a formation that has high porosity and a large amount of water, and resistivity may be relatively high for a formation that has low porosity or includes a large amount of hydrocarbon. Water saturation indicates the fraction of water in a given pore space.

Keeping with FIG. 1, the well environment (100) may include a drilling system (110), a logging system (112), a control system (114), and a permeability simulator (160). The drilling system (110) shown in this example includes a drill string, a drill bit, and a mud circulation system for use in drilling the wellbore (104) into the formation (106). The logging system (112) may include one or more logging tools, for use in generating well logs of the formation (106). The logging tool may be a geometry measuring tool such as a sonic scanner, a ground penetrating radar, a digital borehole scanner, and micrologging tools. For example, a logging tool may be lowered into the wellbore (104) to acquire measurements as the tool traverses a depth interval (130) (e.g., a targeted reservoir section) of the wellbore (104). The plot of the logging measurements versus depth may be referred to as a “log” or “well log”. Well logs (104) may provide depth measurements of the well (102) that describe such reservoir characteristics as formation porosity, formation permeability, resistivity, density, water saturation, normal stress, shear stress, and the like. The resulting logging measurements may be stored and/or processed, for example, by the control system (114), to generate corresponding well logs for the well (102). A well log may include, for example, a plot of a logging response time versus true vertical depth (TVD) across the depth interval (130) of the wellbore (104).

Further, the control system (114) may include hardware and/or software for managing drilling operations and/or maintenance operations. For example, the control system (114) may include one or more programmable logic controllers (PLCs) that include hardware and/or software with functionality to control one or more processes performed by the drilling system (110). Specifically, a programmable logic controller may control valve states, fluid levels, pipe pressures, warning alarms, and/or pressure releases throughout a drilling rig. In particular, a programmable logic controller may be a ruggedized computer system with functionality to withstand vibrations, extreme temperatures, wet conditions, and/or dusty conditions, for example, around a drilling rig. Without loss of generality, the term “control system” may refer to a drilling operation control system that is used to operate and control the equipment and/or a drilling data acquisition and monitoring system that is used to acquire drilling process and equipment data and to monitor the operation of the drilling process

Keeping with FIG. 1, a permeability simulator (160) may include hardware and/or software with functionality for storing and analyzing fluid flow characteristics of a fracture. While the permeability simulator (160) is shown at a well site, in some embodiments the permeability simulator (160) may be remote from the well site. In some embodiments, the permeability simulator (160) is implemented as part of a software platform for the control system (114). The software platform may obtain input data acquired by a profilometer, X-Ray CT scanner, or other geometry measuring tool. The software platform may aggregate the data from these systems in real time for a fluid flow simulation. In some embodiments, the control system (114), the logging system (112), and/or the permeability simulator (160) may include a computer system that is similar to the computer system (1000) described below with regard to FIG. 10 and the accompanying description.

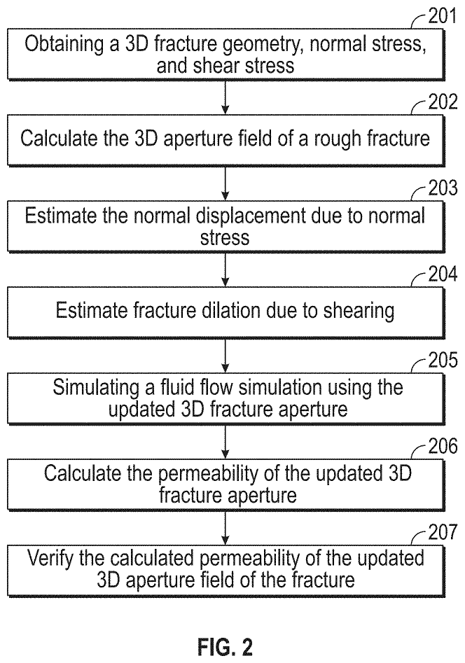

More specifically, in one or more embodiments, FIG. 2 shows a flowchart for predicting stress-dependent fracture permeability under normal and shear deformation through a coupled flow-geomechanics simulation. Specifically, in Block 201 a 3D geometrical description or model of a fracture, normal stress and shear stress may be obtained. The fractures may be natural fractures that preexist the drilling of the wellbore (104) into the hydrocarbon reservoir, and may be the result of current, or ancient, geological stresses generated by tectonic stresses, and the result of the motion of geological formations due to earthquakes on neighboring faults. The fractures may be intersected by the wellbore (104) and provide a preferential flow path that facilitates the flow of fluids, including both hydrocarbons and water, from the hydrocarbon reservoir into the wellbore, and thereafter to a well head and to surface production facilities.

Further, hydraulic fractures may be generated in the hydrocarbon reservoir by pumping a fluid, often primarily water, from a hydraulic fracturing unit on the surface through the well head and the wellbore (104). When the pressure in the wellbore (104) is sufficiently increased by pumping from the hydraulic fracturing unit on the surface, the hydraulic fractures may be created within the hydrocarbon reservoir. Additionally, the fracture may be artificially created in a test sample using a saw or induced using a Brazilian test procedure or a triaxial cell test. Regarding dimensions of the fracture, the fracture length may be tens or hundreds of feet long and the fracture width may be of a similar size. Thickness, the gap between the upper and lower surface of the fracture, denoted as “mechanical aperture”, may be less, often much less, than one inch (0.0254 m) thick at its thickest point. Although the terms “upper surface” and “lower surface” are precise only for a fracture lying substantially in a horizontal plane, the nomenclature “upper” and “lower” will be used herein to denote opposing surfaces of a fracture irrespective of the macroscale orientation of the fracture.

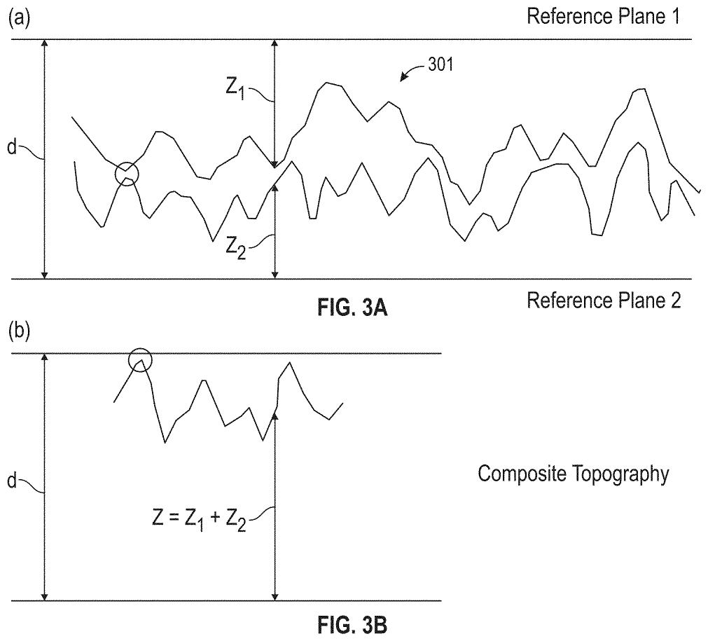

The surface topology of the upper and lower surface of the fracture may be measured using, for example, the profilometer, X-ray computer tomography (CT) scan or other geometry measuring tool. The profilometer may provide nano through macro scale 3D surface measurement of the fractures and operate on a spectral analysis of the fracture. The output of the profilometer is a cloud of points that represents the elevation at each point identified by an x and y coordinate (301) of each point on the fracture surface with respect to a datum, as shown in FIG. 3A. Additionally, or alternatively, a geometric measuring tool may be used to generate an image of the fractured rock. The output image can be processed using a computer program to distinguish the rock from the voids in order to calculate the aperture of the fracture.

Further, in one or more embodiments, Block 202 calculates the size of the aperture of a rough fracture. The calculation of the 3D aperture model of a fracture is based on the obtained measurements of the geometric measuring tool.

As shown in FIG. 3A, a cross-section of 3D rock fractures shows two unmated rough fracture surfaces. Surface elevations are measured from a reference plane 1 and reference plane 2, which are parallel to each other. Z₁ and Z₂ denote surface height from the respective reference plane or distance from the reference plane to x-coordinate of the surface of the fracture. Specifically, Z₁ corresponds to the distance from the reference plane 1 to the upper surface of the fracture and Z₂ corresponds to the distance from the reference plane 2 to the lower surface of the fracture. Distance between the reference planes is denoted with d.

FIG. 3B shows a composite topography, defined as a sum of the upper and lower surface heights which is denoted with Z. A local maximum of the graph representing composite topography in FIG. 3B represents a local minimum aperture shown in FIG. 3A, where asperity contact may form. For example, the aperture at each location may be calculated as:

a₀(x,y)=d−z₁(x,y)−z₂(x,y) Equation (1)

where a₀(x, y) denotes an aperture size at discrete sample points on the graph of a fracture. d denotes distance between the reference plates and z₁(x, y) and z₂(x, y)) denote surface heights with reference to planes 1 and 2, respectively.

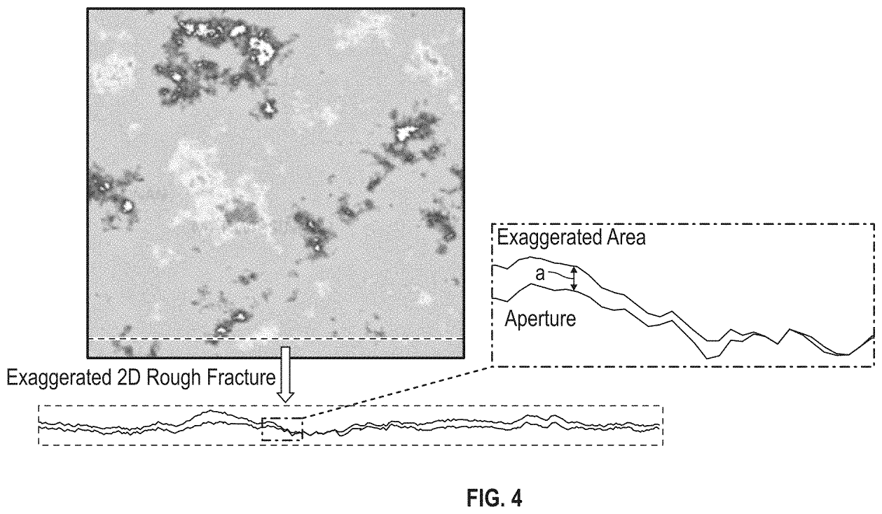

FIG. 4 shows a more detailed example of the aperture where an aperture height is denoted with a. Further, it shows a 2D cross-section of the aperture, with 3 distinct areas. White-colored areas where the aperture is zero represent points where the two fracture surfaces touch one another. Light-gray areas represent the large apertures while dark-gray areas represent the smaller aperture sizes.

Continuing with FIG. 2, Block 203 estimates a normal displacement due to normal stress. The normal displacement may be estimated based on various empirical and theoretical models that estimate a normal closure displacement under normal stress. For example, in accordance with one or more embodiments of this disclosure, the normal displacement may be estimated based on a theoretical normal closure model proposed by Brown and Scholz (“BS”). When combined with the effective normal stress, the BS normal closure model may be written as:

$${σ}_{n , e} = \frac{4}{3} η 〈 Ψ 〉 〈 {E}^{′} 〉 〈 {β}^{\frac{1}{2}} 〉 {\int }_{{d}_{0} - δ}^{∞} {( z - {d}_{0} + δ )}^{\frac{3}{2}} ϕ ( z ) dz \qquad Equation ( 2 )$$

where σ_{n,e} denotes the effective normal stress as input and δ denotes the fracture normal closure displacement as output. Further, η denotes the total number of local maxima per unit area, [symbol] ψ [symbol] denotes the mean of a tangential stress correction factor, [symbol] E′ [symbol] is a mean of an elastic constant, [symbol] β^{1/2} [symbol] is mean of square root of a curvature term, z is height of local maximum, d₀ is distance between the reference planes at σ_{n,e}, and ϕ(z) denotes probability density function for the height of local maxima on the composite topography. All parameters in Eq. (2) may be calculated based on the composite topography, as shown on FIG. 3, as suggested by BS method. Further, a relation between the normal stress and fracture normal closure displacement may be established after obtaining the above-mentioned parameters of Eq. (2). Provided with a given effective normal stress as input, the fracture closure displacement may be obtained accordingly.

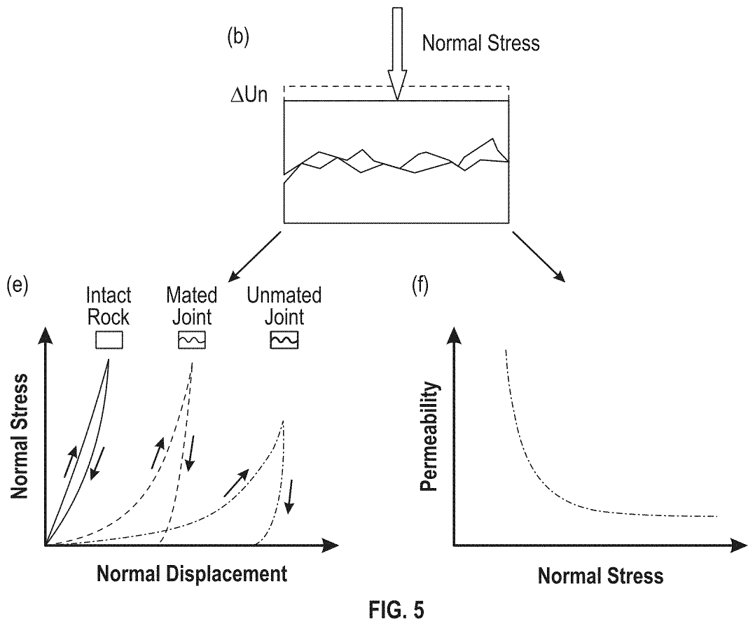

As shown in FIG. 5A, the normal displacement within the fracture aperture is subjected to the normal stress for different scenarios, according to one or more embodiments. For example, the scenarios may include, at least, testing an intact rock, a mated fracture joint, and an unmated fracture joint. Specifically, the scenarios may show hysteresis behavior between loading and unloading process. The relationship between the normal stress and the normal displacement for intact rock shows a linear relation where displacement increases relatively slowly as value normal stress increases. However, rocks with fractures show more significant displacement when the normal stress is acting on them. Specifically, the relation between normal stress and normal displacement is exponential for mated and unmated fractures. However, FIG. 5B shows significantly bigger displacement than rocks with mated fractures. Additionally, FIG. 5B shows the non-linear decrease in fracture permeability when subjected to increasing normal stress which directly affects permeability of rocks with fractures.

Continuing with FIG. 2, Block 204 estimates fracture dilation due to shearing. In this step, shear-induced dilation or negative normal displacement is calculated. The shear-induced dilation is dependent on the roughness of a fracture surface. Specifically, initially the shear dilation model proposed by Barton and Choubey (“BC”), is applied to characterize the relation between a dilation displacement and a shear displacement. The BC shear dilation model could be written as:

$${u}_{n} = {δ}_{s} \cdot tan {α}_{mob} \qquad Equation ( 3 )$$

$$where ,$$

$${α}_{mob} = \frac{1}{M} \cdot {JRC}_{mob} \cdot log ( JCS / {σ}_{n} ) \qquad Equation ( 4 )$$

where, uₙ is the dilation corresponding to the shear displacement δₛ, α_{mob} is the mobilization dilation angle, M is the damage coefficient dependent on normal stress, with values of 1 and 2 corresponding to low and high normal stress, respectively. JRC_{mob} is the mobilized joint roughness coefficient value, and JCS is a fracture wall compression strength.

Based on the given fracture surface topography data, the mobilized joint roughness coefficient value is calculated based on a dimensionless joint roughness coefficient value mobilization model. The relation between the dilation and the corresponding shear displacement may be obtained through Eq. (3). Provided with the shear displacement and the normal stress, fracture dilation uₙ may be obtained accordingly. Following the calculation of fracture dilation uₙ, the aperture, denoted as a_{updated}, may be updated to account for the normal and shear deformation using the formula:

a_{updated}=a₀−δₙ+uₙ Equation (5)

where a₀ is the initial fracture.

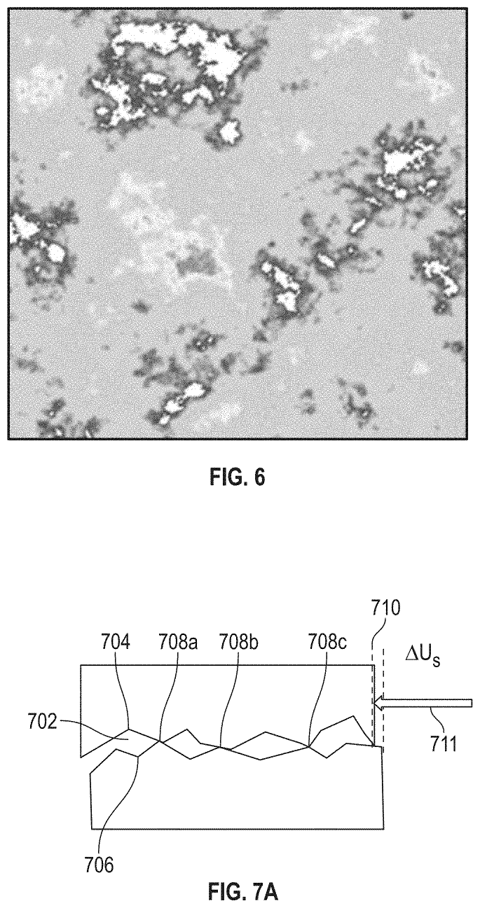

Further, a_{updated} is updated to be zero when a_{updated}<0 to avoid non-physical values. Aperture distributions of rock fracture before and after normal and shear deformation may be obtained to demonstrate the evolution of the aperture. A newly updated 3D topography of the rock fracture is then constructed by subtracting a total fracture closure displacement value (δₙ−uₙ) from an initial 3D fracture topography. An example of a re-constructed 3D aperture following the application of equation is shown in FIG. 6.

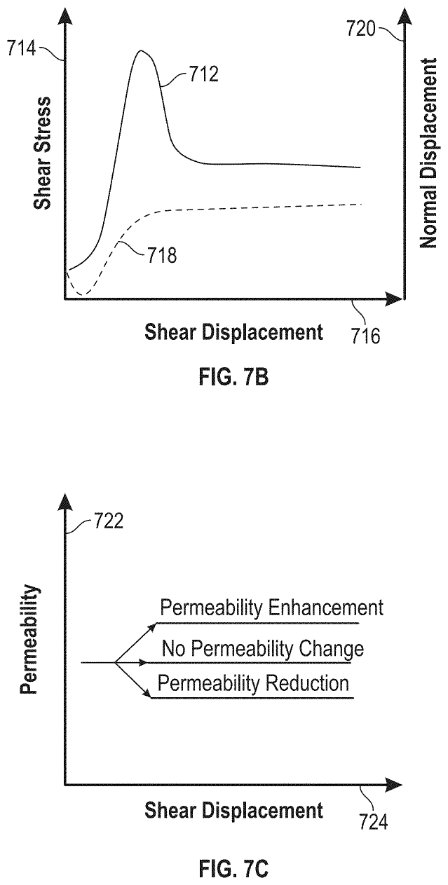

FIGS. 7A-7C depict the complex relation between the shear stress and fracture dilation. FIG. 7A shows a fracture (702) bounded by an upper surface (704) and a lower surface (706). The upper surface (704) and the lower surface (706) touch at a number of points (708a-c). These points (708a-c) may move when the fracture is displaced laterally by a distance ΔUₛ (710) due to a shear stress (711).

In FIG. 7B a solid line (712) represents the magnitude of fracture shear stress, indicated on a left vertical axis (714) for given values shear displacement indicated on a horizontal axis (716). A dashed line (718) represents fracture normal displacement indicated on a right vertical axis (720) for given values shear displacement. Further, FIG. 7C represents different possible scenarios for a permeability change, indicated on a vertical axis (722), due to the shear displacement, indicated on a horizontal axis (724) caused by the shear stress.

Continuing with FIG. 2, Block 205 simulates a fluid flow simulation using an updated 3D aperture model of the fracture. In this step, a high-resolution, full-physics NS simulation is applied to describe the fluid flow through newly updated 3D fractures. Considering a steady-state of incompressible, Newtonian fluid within a laminar flow regime and with negligible gravity effects, the full-physics NS equations can be written as:

ρ(\vec{u}·∇\vec{u})=−∇p+μ∇²\vec{u}

∇·\vec{u}=0 Equation (7)

where ρ is a fluid density, \vec{u} is a velocity, p is a pressure, μ is a dynamic viscosity, ∇² is a Laplacian operator, and ∇ is a gradient operator.

No-slip boundary conditions, where viscous fluids have zero velocity at the fracture wall relative to the solid boundary, are assigned to the fracture walls, and pressure values are imposed at inlet and outlet of the fracture. In one or more embodiments, the NS simulations may be solved using computational fluid dynamics software. The flow rate, denoted as Q, may be calculated by integrating the velocity across the fracture outlet:

Q=∫₀^{w}∫₀^{a}(uₒᵤₜₗᵢₑᵣ·\vec{n})dwda Equation (8)

where w and a are width and aperture of rock fracture, respectively; \vec{u}ₒᵤₜₗₑₜ is the velocity at the outlet; if is a unit vector normal to the outlet.

Block 206 calculates the permeability of the updated 3D aperture model of the fracture. Specifically, the fluid flow in the rock fractures can also be described by Darcy's law for the laminar flow regime. Combined with the Cubic law, fracture permeability, denoted as k, is calculated as:

$${a}_{h} = {( \frac{12 Q μ}{w ∇ P} )}^{1 / 3} \qquad Equation ( 9 )$$

$$k = \frac{{a}_{h}^{2}}{12} = {( 12 )}^{1 / 3} {( \frac{Q μ}{w ∇ P} )}^{2 / 3} \qquad Equation ( 10 )$$

where aₕ is a fracture hydraulic aperture, and ∇P is a pressure gradient along a flow direction.

In one or more embodiments, the permeability of updated 3D aperture model of the fracture may be used to predict a hydrocarbon production rate and hydraulic properties of the fracture. Further, production facilities may be designed based on the predicted hydrocarbon production rate. Specifically, the permeability of updated 3D aperture model of the fracture may be used in other steps of planning and executing a hydrocarbon reservoir production strategy including, without limitation, which completion and stimulation techniques to use and at what locations within the hydrocarbon reservoir, and what type and size of surface hydrocarbon production facilities to construct.

Additionally, the permeability of updated 3D aperture model of the fracture may be used to establish an updated field development plan. The updated field development plan may comprise drilling locations of infill wells and drilling locations of water injection wells. The infill wells are additional wells that target pockets of oil left behind from the original development plan. The water injection wells involve drilling injection wells into a reservoir and introducing water into that reservoir to encourage oil production.

Additionally, modelling stress-sensitive fractures is important for field development and setting production plans of naturally and hydraulically fractured oil and gas reservoirs. Modelling stress-sensitive fractures is especially important for gas reservoirs, as gas is more compressible than oil and water, which makes the impact of stress-sensitivity on the hydrocarbon production. Additionally, rock compression tables may be generated based on the permeability of updated 3D aperture model of the fracture and imported into reservoir simulators for forecasting studies.

Continuing with FIG. 2, Block 207 validates the fracture permeability under different stresses, calculated by the coupled flow-geomechanics simulation using a laboratory test, such as coupled normal-shear-flow laboratory test, on the same fracture. The coupled normal-shear-flow laboratory test may be carried out using a torsional shear device. The torsional shear device is used to measure the effluent flow rate under a constant normal stress value while incrementing the shear displacement.

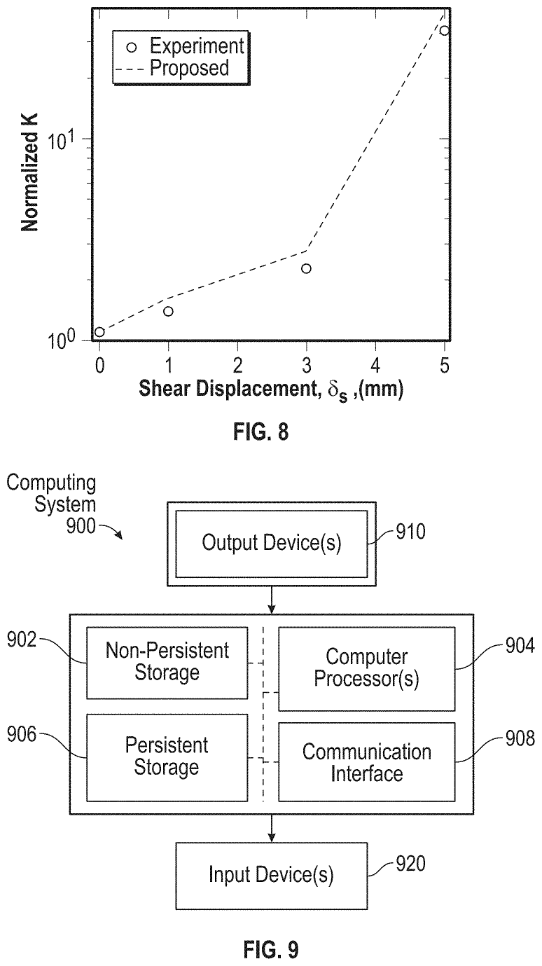

For exemplary purposes, as shown in FIG. 8, for the fracture example used in this embodiment of the disclosure, normal stress was kept constant at 8 MPa while shear displacements were 0, 1, 3 and 5 mm. Further, the measured flow rates are used to back-calculate the fracture permeability at each shear displacement using Eq. (10). Specifically, FIG. 8 shows a plot of the normalized fracture permeability against shear displacement of 0, 1, 3, and 5 mm from the coupled flow-geomechanics simulation and the experiment. In accordance with one or more embodiments of the disclosure, the proposed workflow provides a great insight into the coupling-flow physics and offers an efficient approach to characterize the stress-dependent hydro-geomechanical behaviors of rock fractures when subjected to both compression and shearing processes.

Embodiments may be implemented on a computing system. Any combination of mobile, desktop, server, router, switch, embedded device, or other types of hardware may be used. For example, as shown in FIG. 9, the computing system (900) may include one or more computer processors (904), non-persistent storage (902) (e.g., volatile memory, such as random access memory (RAM), cache memory), persistent storage (906) (e.g., a hard disk, an optical drive such as a compact disk (CD) drive or digital versatile disk (DVD) drive, a flash memory, etc.), a communication interface (908) (e.g., Bluetooth interface, infrared interface, network interface, optical interface, etc.), and numerous other elements and functionalities.

The computer processor(s) (904) may be an integrated circuit for processing instructions. For example, the computer processor(s) may be one or more cores or micro-cores of a processor. The computing system (900) may also include one or more input devices (920), such as a touchscreen, keyboard, mouse, microphone, touchpad, electronic pen, or any other type of input device.

The communication interface (908) may include an integrated circuit for connecting the computing system (900) to a network (not shown) (e.g., a local area network (LAN), a wide area network (WAN) such as the Internet, mobile network, or any other type of network) and/or to another device, such as another computing device.

Further, the computing system (900) may include one or more output devices (910), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (904), non-persistent storage (902), and persistent storage (906). Many different types of computing systems exist, and the aforementioned input and output device(s) may take other forms.

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosure.

While the disclosure has been described with respect to a limited number of embodiments, those skilled in the art, having benefit of this disclosure, will appreciate that other embodiments may be devised which do not depart from the scope of the disclosure as disclosed herein. Accordingly, the scope of the disclosure should be limited only by the attached claims.

Although the preceding description has been described herein with reference to particular means, materials and embodiments, it is not intended to be limited to the particulars disclosed herein; rather, it extends to all functionally equivalent structures, methods and uses, such as are within the scope of the appended claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed is:

1. A method for modeling fluid flow through a fracture, comprising:
obtaining a geometry of the fracture;
determining, using a computer processor, a first three-dimensional (3D) aperture model of the fracture;
estimating, using the computer processor, a normal fracture closure displacement of the first 3D aperture model of the fracture under a normal stress;
estimating, using the computer processor, a fracture dilation of the first 3D aperture model of the fracture under a shear stress;
determining, using the computer processor, a second 3D aperture model of the fracture, wherein the second 3D aperture model is based, at least in part, on the first 3D aperture model, the normal fracture closure displacement, and the fracture dilation;
simulating, using the computer processor, a fluid flow through the second 3D aperture model; and
determining, using the computer processor, a permeability of the second 3D aperture model, at least in part, on the simulated fluid flow.

2. The method of claim 1, further comprising validating the determined permeability of the second 3D aperture model using a coupled normal-shear-flow laboratory test.

3. The method of claim 1, further comprising:
predicting, based on the second 3D aperture model and the determined permeability, a predicted permeability of an in-situ fracture in a field of interest under a plurality of pressures and a plurality of permeabilities;
establishing a field development plan based, at least, on the predicted permeability; and
determining a drilling location based on the established field development plan.

4. The method of claim 1, wherein obtaining the geometry of the fracture comprises measuring a surface topology of each of two fracture surfaces of the fracture using a geometry measuring tool.

5. The method of claim 1, wherein the normal fracture closure displacement of the first 3D aperture model of the fracture under the normal stress is estimated based on a Brown and Scholz normal closure model.

6. The method of claim 1, wherein estimating the fracture dilation of the first 3D aperture model of the fracture under the shear stress is estimated based on a Barton and Choubey dilation model.

7. The method of claim 1, wherein simulating the fluid flow comprises using a Navier-Stokes equation within a laminar flow regime.

8. The method of claim 1, wherein calculating the permeability of the second 3D aperture model of the fracture comprises combining Darcy's law and Cubic law.

9. A non-transitory computer readable medium storing instructions executable by a computer processor, the instructions comprising functionality for:
determining a first three-dimensional (3D) aperture model of a fracture;
estimating a normal fracture closure displacement of the first 3D aperture model of the fracture under a normal stress;
estimating a fracture dilation of the first 3D aperture model of the fracture under a shear stress;
determining a second 3D aperture model of the fracture, wherein the second 3D aperture model is based, at least in part, on the first 3D aperture model, the normal fracture closure displacement, and the fracture dilation;
simulating a fluid flow through the second 3D aperture model; and
determining a permeability of the second 3D aperture model, at least in part, on the simulated fluid flow.

10. The non-transitory computer readable medium of claim 9, wherein obtaining a geometry of the fracture comprises measuring a surface topology of each of two fracture surfaces of the fracture using a geometry measuring tool.

11. The non-transitory computer readable medium of claim 9, wherein the normal fracture closure displacement of the first 3D aperture model of the fracture under the normal stress is estimated based on a Brown and Scholz normal closure mode.

12. The non-transitory computer readable medium of claim 9, wherein estimating the fracture dilation of the first 3D aperture model of the fracture under the shear stress is estimated based on a Barton and Choubey dilation model.

13. The non-transitory computer readable medium of claim 9, wherein the fluid flow simulation is based on a Navier-Stokes simulation, within a laminar flow regime with negligible gravity effects.

14. The non-transitory computer readable medium of claim 9, wherein calculating the permeability of the second 3D aperture model of the fracture comprises combining Darcy's law and Cubic law.

15. The non-transitory computer readable medium of claim 9, further comprising validating the determined permeability of the second 3D aperture model using a coupled normal-shear-flow laboratory test.

16. A system comprising:
a geometry measuring tool; and
a computer processor configured to:
obtain a geometry of a three-dimensional (3D) aperture of a fracture, a normal stress, and a shear stress, based on measurements of the geometry measuring tool;
determine a first three-dimensional (3D) aperture model of the fracture;
estimate a normal fracture closure displacement of the first 3D aperture model of the fracture under the normal stress;
estimate a fracture dilation of the first 3D aperture model of the fracture under the shear stress;
determine a second 3D aperture model of the fracture, wherein the second 3D aperture model is based, at least in part, on the first 3D aperture model, the normal fracture closure displacement, and the fracture dilation;
simulate a fluid flow through the second 3D aperture model; and
determine permeability of the second 3D aperture model, at least in part, on the simulated fluid flow.

17. The system of claim 16, wherein obtaining the geometry of the fracture comprises measuring a surface topology of each of two fracture surfaces of the fracture using the geometry measuring tool.

18. The system of claim 16, wherein the normal fracture closure displacement of the first 3D aperture model of the fracture under the normal stress is estimated based on a Brown and Scholz normal closure mode.

19. The system of claim 16, wherein estimating the fracture dilation of the first 3D aperture model of the fracture under the shear stress is estimated based on a Barton and Choubey dilation model.

20. The system of claim 16, wherein the fluid flow simulation is based on a Navier-Stokes simulation, within a laminar flow regime with negligible gravity effects.
